(19) United States
(12) Patent Application Publication
(10) Pub. No.: US 2012/0306688 A1
(43) Pub. Date: Dec. 6, 2012

(54) GPS MAPPING SYSTEM AND METHOD FOR USE BY HUNTERS, CAMPERS AND OUTDOOR ENTHUSIASTS

(76) Inventors: John Fereghetti, Grand Blanc, MI (US); Robert E. Eastman, II, Grand Blanc, MI (US)

(21) Appl. No.: 13/150,856

(22) Filed: Jun. 1, 2011

(51) Int. Cl. G01S 19/42; G01S 19/19

(52) U.S. Cl. 342/357.25; 342/357.57

(57) ABSTRACT

A tracking and mapping system for outdoor use includes a first GPS locator located either at a base station or on a hunting accessory such as an arrow. The system also includes a second GPS locator for identifying a user's location, and an electronic display unit for communicating with a global positioning satellite and displaying a map showing icons representing locations of the first and second GPS locators. The second GPS locator may be embedded in the electronic display unit, which may be a mobile wireless handheld device, a tablet or other portable computer having wireless connectivity. The electronic display unit maps the present location of each of the GPS locators in relation to a direction such as north, south, east or west. Optionally, separate GPS locators may be placed at a base station and in an arrow. A method of using the tracking and mapping system is also described.

### BACKGROUND OF THE INVENTION

1. Field of the Invention

The present invention relates to a mapping system using a plurality of global positioning system (GPS) tracking units together with signals from existing GPS satellites, for assisting a user in orienting the user's present location relative to a piece of outdoor equipment equipped with a GPS locator, and also to a method of using the described system. More particularly, the present invention relates to a GPS mapping system and method as described including a user application installed on a commercially available electronic display unit.

2. Description of the Background Art

A number of different apparatus and methods are known for tracking arrows and other outdoor equipment using GPS sensors.

Examples of some of the known apparatus include those described in U.S. Pat. No. 6,459,372 to Branham et al., U.S. Pat. No. 6,898,526 to Doyle et al., U.S. Pat. No. 6,952,881 to McGivern, U.S. Pat. No. 7,632,199 to Kikos, U.S. Pat. No. 7,780,363 to Holmberg, Published US Patent Application 2003-0132846 to Hilliard, and Published US Patent Application 2010-0035709 to Russell et al.

In addition, the use of GPS mapping devices has become relatively widespread including commercial products such as TomTom®, Garmin® and Magellan®. In addition, some smart phones are available today with built-in GPS receivers and mapping software.

Although the known devices have some utility for their intended purposes, a need still exists in the art for a system and method which can adapt a commercially available GPS mapping apparatus to work with a hunting or camping accessory having a GPS locator therein. In particular, there is a need for such a system and method which will be usable by a hunter or outdoor enthusiast in an undeveloped natural area where roads are limited or absent.

### SUMMARY OF THE INVENTION

Accordingly, it is an object of the present invention to provide a tracking and mapping system for outdoor use, where the system includes a first GPS locator located either at a base station or on a hunting accessory such as an arrow.

It is another object of the present invention to provide a method of using the described system in an outdoor environment to keep track of an outdoor accessory using a GPS homing signal.

The system also includes a second GPS locator for identifying a present location of a user, and an electronic display unit for communicating with a global positioning satellite and displaying a map showing icons representing relative locations of the first and second GPS locators. The electronic display unit may be a mobile wireless handheld device such as a smartphone, a Wireless Application Protocol (WAP) device, a personal digital assistant, or a portable computer having wireless connectivity.

Optionally, if the first GPS locator is mounted on a hunting arrow, the system may include a third GPS locator for placement at a base station.

The second GPS locator may be embedded in the electronic display unit, which may a mobile wireless handheld device, a tablet or other portable computer having wireless connectivity.

It is necessary to electronically synchronize the first GPS locator with the electronic display unit, in order to enable the electronic display unit to display a symbol or icon representing the first GPS locator on the map. In addition, a radio communication link may be provided between the first GPS locator and the electronic display unit, to enable the electronic display unit to map a present location of the first GPS locator.

After the electronic display unit has been synchronized with the first GPS locator, the electronic display unit is operable to map a present location of each of the GPS locators in relation to a direction such as north, south, east or west.

Optionally, separate GPS locators may be placed at one or more base stations and also in an arrow.

The electronic display unit may be operable to show the present location of each of the first and second GPS locators on a map in relation to at least one direction selected from north, south, east and west, in order to help a user who can determine these directions, orient him or herself in relation to the map.

Optionally, the electronic display unit may be operable to show both a present location of the first GPS locator and a former location thereof at an earlier time, in order to help display a direction of movement of the first GPS locator on the map relative to the location of the second GPS locator.

The electronic display unit may be programmed to show a uniquely colored icon, or other type of distinctive visual symbol or icon for each of the GPS locators used by the system. Optionally, the specific symbol used for each GPS locator may be selected by the user from a menu.

Methods

1. Homing Signal Method

The present invention also encompasses a method of keeping track of a homing signal from a first GPS locator with an electronic display unit equipped with a second GPS locator in an outdoor environment, where the first GPS locator has been operatively installed on an outdoor accessory which is either a hunting arrow, a tent, a trailer, a hunting blind, an observation stand or a vehicle such as a recreational vehicle or camper van.

The homing signal method includes a first step of electronically synchronizing the first GPS locator with the electronic display unit, so that the electronic display unit is able to communicate with the first GPS locator and to receive signals which indicate a location of the first GPS locator.

The homing signal method also includes another step of spacing the first and second GPS locators apart from one another, which involves putting at least one of the GPS locators in motion.

The homing signal method also includes another step of viewing a map on the electronic display unit which has been electronically synchronized with the first GPS locator, where the map shows symbols representative of both the first GPS locator and a second GPS locator embedded in the electronic display unit.

The homing signal method also includes another step of using the map as a guide to move the second GPS locator towards a location of the first GPS locator.

2. Arrow Tracking Method

The present invention also encompasses a method of tracking an arrow equipped with a first GPS locator with an electronic display unit. The arrow tracking method includes a first step of electronically synchronizing a first GPS locator, operatively installed on a hunting arrow, with an electronic display unit so that the electronic display unit is able to communicate with the first GPS locator and to receive signals which indicate a location of the first GPS locator.

The arrow tracking method also includes another step of loading an arrow equipped with the first GPS locator on a bowstring of a bow and shooting the arrow towards a target, which may be a game animal.

The arrow tracking method also includes another step of viewing a map on the electronic display unit which has been electronically synchronized with the first GPS locator, where the map shows symbols representative of both the first GPS locator and a second GPS locator embedded in the electronic display unit. The electronic display unit is operable to receive signals from a global positioning satellite and to display the map showing a present location of each of the first and second GPS locators, respectively.

The arrow tracking method also includes another step of using the map as a guide to move the second GPS locator towards a location of the first GPS locator, which is likely to help the user track the game animal.

For a more complete understanding of the present invention, the reader is referred to the following detailed description section, which should be read in conjunction with the accompanying drawings. Throughout the following detailed description and in the drawings, like numbers refer to like parts.

### BRIEF DESCRIPTION OF THE DRAWINGS

FIG. 1 is a simplified schematic diagram showing electronic communication between a first GPS locator mounted on a hunting arrow, a GPS communications satellite, and an electronic display unit.

FIG. 2A is a first plan view of the electronic display unit of FIG. 1, showing a screen used in synchronizing a first GPS locator with the electronic display unit.

FIG. 2B is a second plan view of the electronic display unit, showing a screen which is a map showing selected topographical features, and displaying icons representing present locations of both the first GPS locator and the electronic display unit.

FIG. 2C is a schematic diagram of the contents of the first GPS locator.

FIG. 3 is a simplified schematic diagram showing electronic communication between a GPS locator mounted on a tree stand, a GPS communications satellite, and the electronic display unit.

FIG. 4 is a simplified schematic diagram showing electronic communication between a GPS locator mounted on a hunting blind, a GPS communications satellite, and the electronic display unit; and

FIG. 5 is a simplified schematic diagram showing electronic communication between a GPS locator mounted on a camping trailer, a GPS communications satellite, and the electronic display unit.

### DETAILED DESCRIPTION OF ILLUSTRATIVE EMBODIMENTS

It should be understood that only structures considered necessary for clarifying the described embodiments of the present invention are described herein. Other conventional structures, and those of ancillary and auxiliary components of the system, will be known and understood by those in the art.

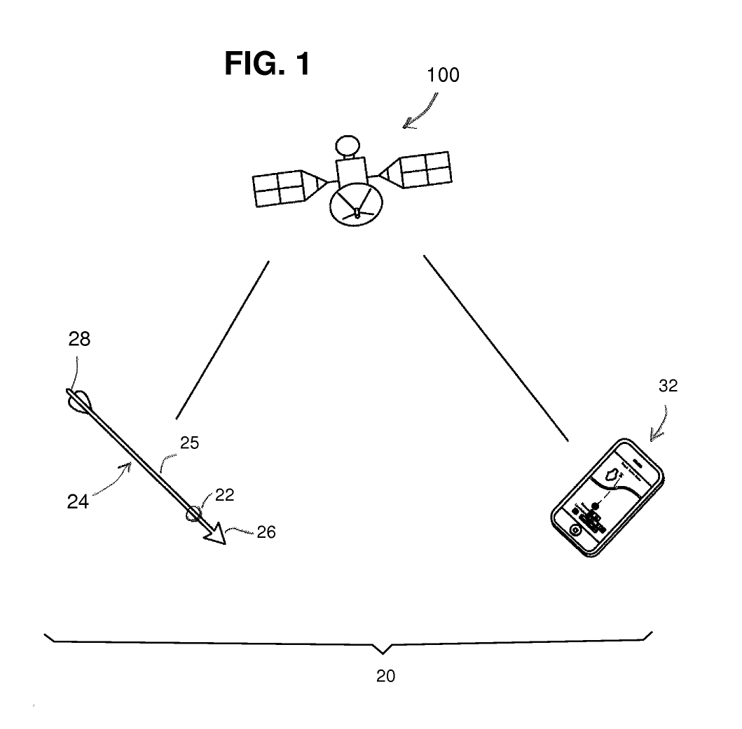

Referring now to FIG. 1 of the drawings, a first embodiment of the present invention provides a tracking and mapping system 20 for outdoor use in conjunction with a GPS satellite 100, where the system 20 includes a first GPS locator 22 located on a hunting accessory such as an arrow 24. Where an arrow 24 us used as part of the system, the first GPS locator 22 may be attached to the arrow shaft 25, to the arrowhead 26, or to the nock 28.

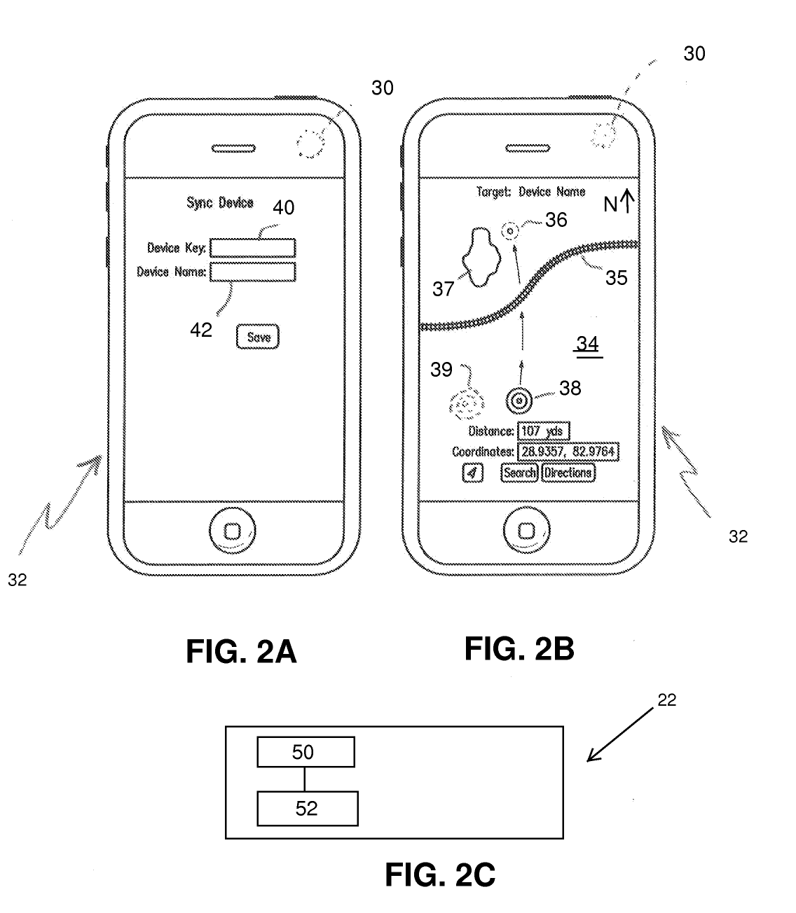

As shown in FIG. 2C, the first GPS locator 22 may include both a conventional GPS receiver 50 and a radio frequency (RF) transmitter 52 that is operable to relay the coordinates of the first GPS locator to an electronic display unit 32. The transmitter 52 could communicate using an existing protocol (e.g., WiFi, Short Message Service (SMS), Global System for Mobile Communications (GSM) or a custom protocol, via satellite or terrestrial radio links. The first GPS locator 22 could communicate directly with the electronic display unit 32 or indirectly, using an intermediary base station which could be located at a tent, a trailer, a hunting blind, an observation stand or a vehicle such as a recreational vehicle or camper van.

The system 20 is designed to work in conjunction with existing GPS satellites 100.

The present invention also provides methods of using the system 20 in an outdoor environment to keep track of an outdoor accessory using a GPS homing signal. The system 20 is described first herein, and the methods are described subsequently.

The system 20 also includes a second GPS locator 30 (FIG. 2) for identifying a present location of a user (not shown), and an electronic display unit 32 for communicating with a global positioning satellite 100 and for displaying a map 34 showing icons 36, 38 representing relative locations of the first and second GPS locators.

Preferably, the second GPS locator 30 is embedded in the electronic display unit 32. The electronic display unit 32 may be a mobile wireless handheld device such as a smartphone, a Wireless Application Protocol (WAP) device, a personal digital assistant (PDA), or a portable computer having wireless connectivity.

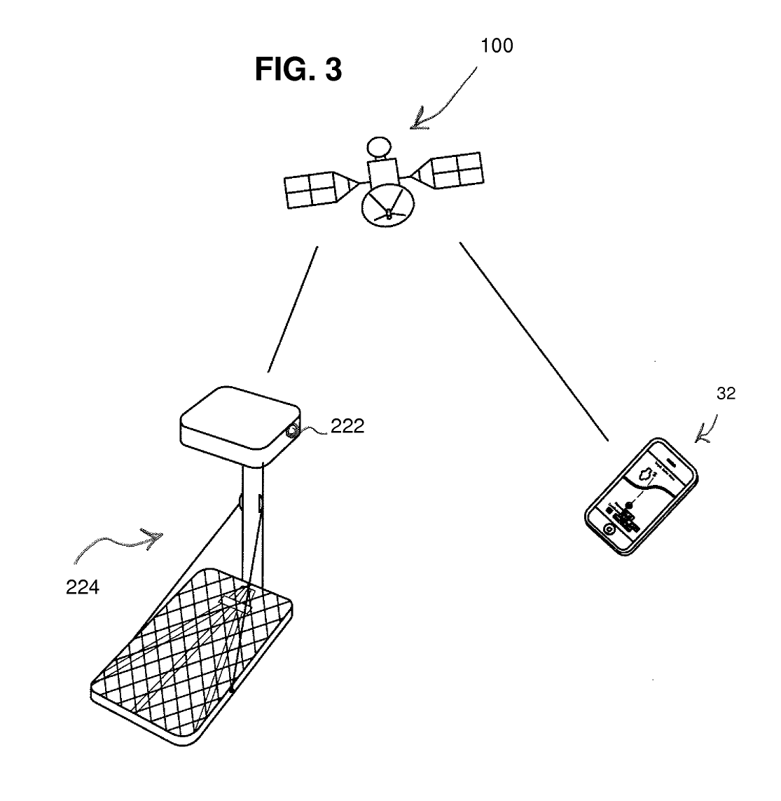

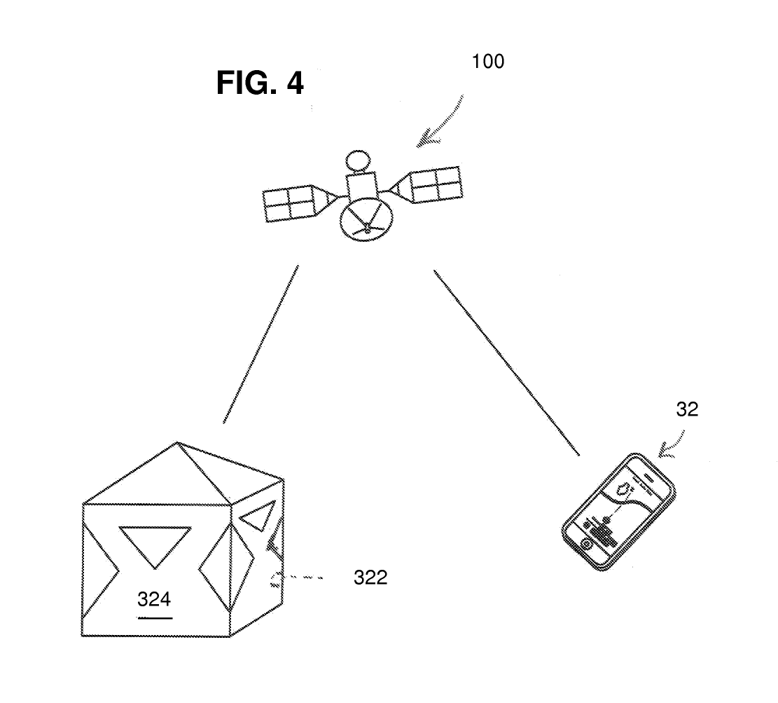

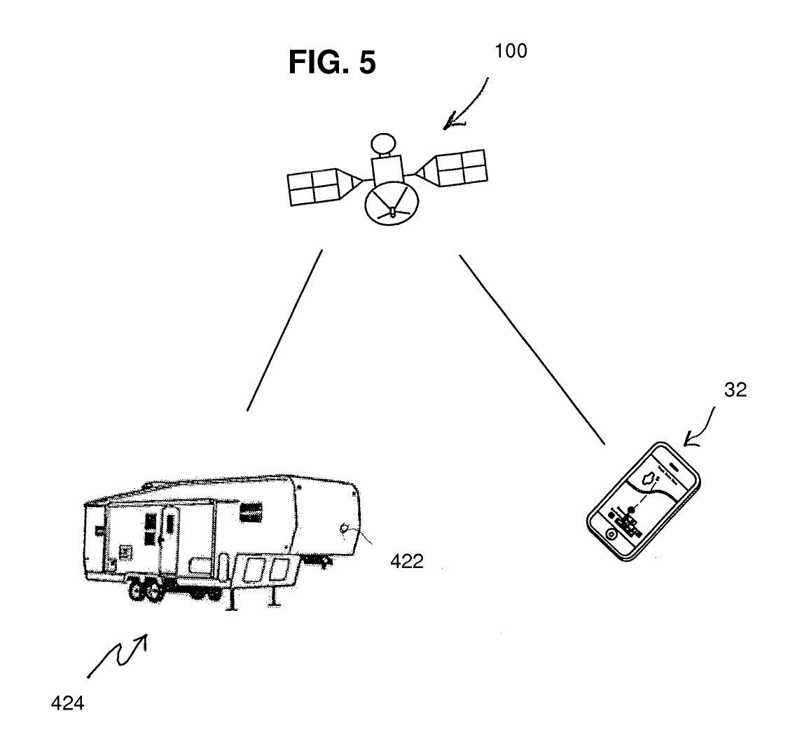

Optionally, if the first GPS locator is mounted on a hunting arrow, the system 20 may include a third GPS locator 222, a fourth GPS locator 322 and/or a fifth GPS locator 422 for placement at a base station, where the base station may be an observation stand 224 (FIG. 3) or a portable shelter, which may be a tent 324 (FIG. 4) or camper 424 (FIG. 5).

It is necessary to electronically synchronize the first GPS locator 22 with the electronic display unit 32, in order to enable the electronic display unit to display a symbol or icon representing the first GPS locator on the map 34. Such synchronization is accomplished using a specialized software application which has been installed on the electronic display unit 32, and a screen showing such synchronization is shown in FIG. 2A. Synchronizing the first GPS locator 22 with the electronic display unit 32 may involve entry of a serial number for the first GPS locator into a first data field 40 and assigning a user-selected device name to the first GPS locator, such as, e.g., “arrow-1”.

After the electronic display unit 32 has been synchronized with the first GPS locator 22, the electronic display unit 32 is operable to map a present location of each of the GPS locators 22, 30 in relation to a direction such as north, south, east or west, and optionally in relation to topographical features such as, for example, roads, railroad tracks 35 or bodies of water such as lakes, streams or ponds 37. Other data may be displayed on the map 34, such as distance between the first GPS locator 22 and the electronic display unit 32.

Optionally, separate GPS locators may be placed at one or more base stations and in an arrow.

The electronic display unit 32 may be operable to show icons 36, 38 representing the present location of each of the first and second GPS locators on the map 34 in relation to at least one direction selected from north, south, east and west, in order to help a user who can independently determine these directions, orient him or herself in relation to the map. The user may be able to figure out which directions are north, south, east and west using a compass, or from looking at the position of the sun.

Optionally, the electronic display unit may be operable to show icons 38, 39 representing both a present location of the first GPS locator and a former location thereof at an earlier time, in order to help display a direction of recent movement of the second GPS locator on the map relative to the location of the first GPS locator.

The electronic display unit may be programmed to show a uniquely colored icon, or another graphically distinctive visual symbol or icon for each of the GPS locators 22, 30, 222, 322 used by the system. Optionally, the specific symbol used for each GPS locator in the system may be pre-selected by the user from a menu.

Methods

1. Homing Signal Method

The present invention also encompasses a method of keeping track of a homing signal from a first GPS locator 22 with an electronic display unit 32 equipped with a second GPS locator 30 in an outdoor environment, where the first GPS locator has been operatively installed on an outdoor accessory which is either a hunting arrow 24, a portable shelter 324, an observation stand such as a tree stand 224, a ladder stand (not shown) or in a vehicle such as a camper 422 (FIG. 5), van or recreational vehicle.

The homing signal method includes a first step of electronically synchronizing the first GPS locator 22 with the electronic display unit 32, so that the electronic display unit 32 is able to communicate with the first GPS locator 22 via a radio link to receive location data from the GPS satellite 100, and to receive signals from the satellite which indicate a current location of the first GPS locator.

The homing signal method also includes another step of spacing the first and second GPS locators 22, 30 apart from one another, which involves putting at least one of the GPS locators in motion.

The homing signal method also includes another step of viewing a map 34 on the electronic display unit 32 which has been electronically synchronized with the first GPS locator 22, where the map shows symbols 36, 38 representative of both the first GPS locator 22 and the second GPS locator 30 embedded in the electronic display unit.

The homing signal method also includes another step of using the map 34 as a guide to move the second GPS locator 30 towards a location of the first GPS locator 22.

In one embodiment of the invention, the homing signal method may involve mapping a signal from a stationary base station and another signal from the mobile electronic display unit to track a user's present mobile location relative to the base station. This may be useful in helping a hiker or outdoorsman find his or her way back to the base station.

2. Arrow Tracking Method

The present invention also encompasses a method of tracking an arrow 24 equipped with a first GPS locator 22, using an electronic display unit 32 equipped with a second GPS locator 30. The arrow tracking method includes a first step of electronically synchronizing the first GPS locator 22, operatively installed on a hunting arrow 24, with the electronic display unit 32 so that the electronic display unit is able to communicate with the first GPS locator 22 via a radio link to receive location data from the GPS satellite 100, and to receive signals which indicate a location of the first GPS locator 22.

The arrow tracking method also includes another step of loading the arrow 24 equipped with the first GPS locator 22 on a bow and shooting the arrow towards a target (not shown), which may be a game animal.

The arrow tracking method also includes another step of viewing a map 34 on the electronic display unit 32 which has been electronically synchronized with the first GPS locator 22, where the map shows symbols 36, 38 representative of both the first GPS locator 22 and a second GPS locator 30 embedded in the electronic display unit. The electronic display unit 32 is operable to receive signals from a global positioning satellite 100 and to display the map 34 showing symbols 36, 38 representative of a present location of each of the first and second GPS locators 22, 30, respectively.

The arrow tracking method also includes another step of using the map 34 as a guide to move the second GPS locator 30 towards a location of the first GPS locator 22, which is likely to help the user track the game animal. If the user has wounded the target game animal with the arrow 24, it will be understood that the animal will eventually stop moving, and the user will be able to locate the animal using the signals from the first GPS locator 22. If the user also has another, additional GPS locator at a base station such as a portable shelter 324 (FIG. 4), then the system hereof can assist the user in re-locating the base station after locating the game animal.

3. User Location Mapping Method

The present invention also encompasses a method of mapping a location of a user in relation to a equipped with a first GPS locator 22, using an electronic display unit 32 equipped with a second GPS locator 30. The arrow tracking method includes a first step of electronically synchronizing the first GPS locator 22, operatively installed on a base station 224, 324 or 424 with the electronic display unit 32 so that the electronic display unit is able to communicate with the first GPS locator 22 via a radio link to receive location data from the GPS satellite 100, and to receive signals which indicate a location of the first GPS locator 22.

The user location mapping method also includes another step of moving the user and the electronic display unit 32 away from the base station. This may involve walking on a hiking trail or across open land.

The user location mapping method also includes another step of viewing a map 34 on the electronic display unit 32 which has been electronically synchronized with the first GPS locator 22, where the map shows symbols 36, 38 representative of both the first GPS locator 22 and a second GPS locator 30 embedded in the electronic display unit. The electronic display unit 32 is operable to receive signals from a global positioning satellite 100 as well as to communicate with the base station, and to display the map 34 showing symbols 36, 38 representative of a present location of each of the first and second GPS locators 22, 30, respectively.

The user location mapping method also includes another step of using the map 34 as a guide to move the second GPS locator 30 towards a location of the first GPS locator 22, which is likely to help the user move back to the base station.

Although the present invention has been described herein with respect to a number of specific illustrative embodiments, the foregoing description is intended to illustrate, rather than to limit the invention. Those skilled in the art will realize that many modifications of the illustrative embodiment could be made which would be operable. All such modifications, which are within the scope of the claims, are intended to be within the scope and spirit of the present invention.

Having, thus, described the invention, what is claimed is:

1. A tracking system for use by a hunter, said system comprising:
an arrow having a first GPS (global positioning system) locator associated therewith;
a second GPS locator for carrying by a user and for sending signals indicative of a present location thereof; and
an electronic display unit operable to receive signals from a global positioning satellite and with the first and second GPS locators, wherein the electronic display unit is operable to display a map showing a present location of each of the first and second GPS locators, respectively.

2. The tracking system of claim 1, wherein the second GPS locator is embedded in the electronic display unit.

3. The tracking system of claim 1, wherein the electronic display unit is operable to show said present location of each of the first and second GPS locators on said map in relation to at least one direction selected from north, south, east and west.

4. The tracking system of claim 1, wherein the electronic display unit is either a mobile wireless handheld device, a Wireless Application Protocol (WAP) device, a personal digital assistant, or a portable computer having wireless connectivity.

5. The tracking system of claim 1, wherein the electronic display unit has been electronically synchronized with the first GPS locator to enable it to display the location thereof.

6. The tracking system of claim 1, wherein the electronic display unit is be operable to show both a present location of the first GPS locator and a previous location thereof, in order to help display a direction of movement of the first GPS locator on the map relative to the location of the second GPS locator.

7. The tracking system of claim 1, further comprising a third GPS locator for placement at a base station selected by the user.

8. A method of tracking an arrow equipped with a first GPS locator, comprising the steps of:
a) electronically synchronizing a first GPS locator, operatively installed on a hunting arrow, with an electronic display unit so that the electronic display unit is able to communicate with the first GPS locator and to receive signals which indicate a location of the first GPS locator loading an arrow equipped with a first GPS locator on a bowstring of a bow;
b) shooting the arrow towards a target;
c) viewing a map on an electronic display unit which has been electronically synchronized with the first GPS locator, said electronic display unit having a second GPS locator therein and operable to receive signals from a global positioning satellite and to display said map showing a present location of each of the first and second GPS locators, respectively; and
using the map as a guide to move towards a location of the first GPS locator.

9. The method of claim 8, wherein the second GPS locator is embedded in the electronic display unit.

10. The method of claim 8, wherein the electronic display unit is operable to show a uniquely colored icon for each of the GPS locators.

11. The method of claim 8, wherein the electronic display unit is either a mobile wireless handheld device, a Wireless Application Protocol (WAP) device, a personal digital assistant, or a portable computer having wireless connectivity.

12. A method of keeping track of a homing signal from a first GPS locator with an electronic display unit equipped with a second GPS locator in an outdoor environment, where the first GPS locator has been operatively installed on an outdoor accessory which is either a hunting arrow, a tent, a trailer, a hunting blind, an observation stand or a vehicle, said method comprising the steps of:
a) electronically synchronizing the first GPS locator with the electronic display unit, so that the electronic display unit is able to communicate with the first GPS locator and to receive signals which indicate a location of the first GPS locator;
b) spacing the first and second GPS locators apart from one another by putting at least one of the first and second GPS locators in motion;
c) viewing a map on the electronic display unit which has been electronically synchronized with the first GPS locator, where the map shows symbols representative of both the first GPS locator and a second GPS locator embedded in the electronic display unit; and
d) using the map as a guide to move the second GPS locator towards a location of the first GPS locator.
